(19) United States
(12) Patent Application Publication
(10) Pub. No.: US 2007/0182063 A1
(43) Pub. Date: Aug. 9, 2007

(54) Method for making a plastic molded part

(75) Inventors: Fabian Gwosdz, Schorndorf (DE); Jorg Schlossarczyk, Winnenden (DE)

Correspondence Address: WALTER OTTESEN, PO BOX 4026, GAITHERSBURG, MD, 20885-4026, US

(73) Assignee: Andreas Stihl AG & Co. KG.

(21) Appl. No.: 11/698,086

(22) Filed: Jan. 26, 2007

(30) Foreign Application Priority Data
Feb. 4, 2006 (DE) 10 2006 005 096.7

(51) Int. Cl. B29C 45/14

(52) U.S. Cl. 264/259; 264/328.1

(57) ABSTRACT

A method for making a plastic molded part (12) includes injecting plastic (13) into a foil part (2) with plastic (13) being injected into an injection mold (7) at the rear side of the foil part. The plastic molded part (12) is especially a housing component of a portable handheld work apparatus. The method includes providing a plurality of foil parts (2) in a foil strip (1). Thereafter, the foil strip (1) is positioned in the work region of the injection mold (7). A foil part (2) is taken out of the foil strip (1) utilizing a grabber (6) and is placed in the injection mold (7). Thereafter, the foil part (2), which is placed in the injection mold (7), is back injected with the plastic (13).

### CROSS REFERENCE TO RELATED APPLICATION

This application claims priority of German patent application no. 10 2006 005 096.7, filed Feb. 4, 2006, the entire content of which is incorporated herein by reference.

### FIELD OF THE INVENTION

The invention relates to a method for making a plastic molded part and especially for making a housing component part of a portable handheld work apparatus.

### BACKGROUND OF THE INVENTION

Injection molded plastic molded parts are often provided on the side viewed by an observer with a designation, marking, information as to use or the like. For this purpose, printed foils are widely used which are placed on the top side which is viewed. In mass manufacture, such plastic molded parts are often manufactured in that a corresponding foil part is placed in an injection mold and thereafter plastic is back injected. The additional work step of a subsequent manual application of the foil part is omitted. An intimate bond arises between the foil part and the back injected plastic material. During rough operation and use, especially of portable handheld work apparatus, back injected foil parts exhibit a high resistance to wear.

Such foil parts are printed in a printing facility and are supplied in stacks to the manufacturer of the plastic molded parts. Finished stamped-out foil parts are positioned in stacks in the work region of the injection mold and can be placed into the injection mold by means of a grabber.

In the practical operation of manufacturing, making available the individual foil parts in stacks can lead to difficulties. A position-precise readiness for use is complex and is associated with risk of an incorrect positioning. Separating out individual foil parts, stacking and positioning are complex and cost intensive.

### SUMMARY OF THE INVENTION

It is an object of the invention to provide a method for making a plastic molded part wherein the complexity of preparation to back inject a foil part is reduced.

The method of the invention is for making a plastic form part including a housing part of a portable handheld work apparatus. The method includes the steps of: providing a foil strip containing a plurality of foil parts; positioning the foil strip in a work region of an injection mold; taking a foil part from the foil strip and placing the foil part in the injection mold utilizing a grabber; and, injecting plastic into the injection mold so as to cause the plastic to be applied to the foil part at the rear side thereof.

A method is suggested wherein a plurality of foil parts is assembled in a foil strip. The foil strip is positioned in the work region of the injection mold. Thereafter, an individual foil part is taken from the foil strip by means of a grabber and is placed in the injection mold. Finally, the foil part, which is placed in the injection mold, is back injected with the plastic.

The foil parts can be punched out so as to be complete and be positioned on a carrier strip, for example, via a loose adhesion or, as non-separated sections of the foil strip, the foil parts can be punched out of the foil strip directly in advance of their take up or can be separated in other ways. It is practical to partially punch out the foil part from the foil strip while retaining connecting segments. The remaining regions of the foil strip define a carrier lattice for the foil part and the connecting segments are cut through directly in advance of or with the removal of the foil part from the carrier lattice.

Foil strips of this kind can be printed in a printing facility and punched out or prepunched in a suitable manner. The foil parts can be supplied in the form of rolls which can then be positioned in the work region of the injection mold. The foil strip keeps the individual foil parts together. In the foil strip, the foil parts have a fixedly defined position. A slippage is reliably prevented. When unwinding the foil strip from the spool, the individual foil parts assume their designated position with high process reliability. This position is maintained by the foil strip directly up to removal. The flexible foil strip can be easily manipulated, rolled up or even partially unwound without the individual form parts dropping out or changing their predetermined positions.

In the partially punched out embodiment, the connecting segments hold the foil part in position. A separate carrier foil is not required. The separation of the thin connecting segments can take place with little complexity directly with the removal or take up by the grabber. The remaining carrier lattice contains only a small quantity of cut material and can be easily disposed of.

The separation of the connecting segments can take place directly in advance of the take up of the foil part with a suitable knife tool or the like. In a practical embodiment of the invention, the separation of the connecting segments takes place by means of the grabber wherein especially the grabber tears out the foil part from the carrier lattice. The connecting segments only have a holding function for the foil parts in the carrier lattice and the occurring holding forces are low so that the connecting segments can be very small and thin. The separation via a simple tearing out takes place precisely without damage of the foil edges in the region of the connecting segments. A subsequent processing of the foil edges is not required and a separate cutting tool is not needed.

In an advantageous embodiment of the method, the foil strip is held between a hold-down device and a support when taking up the foil part and the foil part is separated from the foil strip and is especially punched out or torn out. In the process of separating the foil part, the foil strip remains fixed and cannot slip. High forces can be applied to the foil part to be separated and this makes possible a clean punch out or tearing through of the connecting segments.

In a preferred embodiment, positioning marks are assigned to the foil parts in the foil strip. The foil strip is positioned by means of the positioning marks for taking up the foil part. In the same manner, a precise alignment of the foil part, which is to be removed, can be achieved by means of the positioning mark relative to a separating device as well as relative to the grabber. Inaccurate adjustments, waste and the requirement of a manual correction are avoided.

In a practical embodiment, a foil part is back injected which foil part is made of the same plastic material as the back injected plastic. Especially polyamide is provided for the foil part and the back injected plastic. In this way, it is ensured that, when back injecting, an intimate materially unified bond arises between the foil part and the back injected plastic. Where the two plastics come directly together, a bonding agent or the like can be avoided. With the selection of polyamide (especially PA 6), optically pleasing and highly durable surfaces result. The characterizing function and aesthetic effect of the foil part is maintained for a long time.

In a preferred embodiment, the foil part comprises a clear plastic imprinted at least partially on the rear side. The foil part has a rear side facing toward the back injected plastic. Practically, the foil part is provided with a bonding agent on this rear side. Especially, an applied printing ink can define the bonding agent. The rear side printing leads to the situation that the foil part is back injected on its printed side. The printing ink is protected on the completed component by the foil part of clear plastic. The imprinted pattern is visible without limitation through the clear plastic. The visibility and recognizability are maintained even when the outer surface is scratched. With the printing ink as bonding agent, an intimate connection is ensured between the foil part and the back injected plastic in the printed region. In the non-printed regions, a like intimate material bond is established by a suitable material combination of foil material and back injected plastic.

In an advantageous embodiment, the back injected plastic is a through dyed plastic and is especially a filled plastic. The color of the through dyed plastic shines through the non-printed sections of the clear foil part. The printing ink on the back injected foil part forms a contrast to the color of the back injected plastic. The color continues from the non-imprinted clear sections into the regions outside of the foil part. The contour of the foil part is not perceived by the viewer when there is a corresponding print pattern. Only the optical impression of the applied print pattern remains. Also, with complex print patterns, the foil part itself can exhibit a simple geometric configuration, for example, in the form of a rectangle. Manufacturing and manipulating are simplified. Additionally, a filling, for example, in the form of glass fibers or the like can be provided in the plastic to be back injected. This increases the material strength.

The foil part has a thickness in the range of 14 μm to 200 μm inclusive. The thickness is especially approximately 14 μm. A ratio of the thickness of the foil part to the total thickness of the plastic molded part in the region of the back injected foil part is less than 0.5. In the value ranges given above, a good compromise between the load carrying capability of the plastic molded part overall and a protective function of the foil part with respect to applied printing ink has been found. The thin foil permits a vapor permeability which avoids the formation of bubbles.

In a further embodiment, the foil part is placed in a surface region of the injection mold with this surface region being essentially smooth. The smooth surface region is greater than the foil part. This larger smooth surface region is imparted to the finished plastic form part after the injection operation. The outer surface of the injected plastic material continues without steps into the front side surface of the foil part. The stepless transition avoids the situation during operation that the lateral edges of the foil part are subjected to load. When a foreign body hits the foil part, it slides off. The problem of a lifting off and separation of the foil edge is prevented.

### BRIEF DESCRIPTION OF THE DRAWINGS

The invention will now be described with reference to the drawings wherein:

FIG. 1 is a schematic plan view of a foil strip having partially stamped out foil parts provided for placement in an injection mold;

FIG. 2 shows an embodiment of the foil strip of FIG. 1 with the foil strip having a perforated edge and a positioning mark;

FIG. 3 is a schematic showing the operation of the removal of a foil part from the foil strip of FIGS. 1 or 2 and positioning the foil part in a mold recess;

FIG. 4 is a side elevation view of the arrangement of FIG. 3 in the region of the foil strip with the arrangement including a support, guide rollers as well as an unwind unit and a wind-up unit for the foil strip;

FIG. 5 is a longitudinal section view showing the support of FIG. 4 with details of a punch-out apparatus;

FIG. 6 is a schematic cross-sectional view of the closed injection mold of FIG. 3 with a foil part placed therein and injected plastic; and,

FIG. 7 is an enlarged schematic section view of the plastic part produced in the injection mold of FIG. 6 in the region of the detail VII identified in FIG. 6 including details of the arrangement of the foil part relative to the back injected plastic.

### DESCRIPTION OF THE PREFERRED EMBODIMENTS OF THE INVENTION

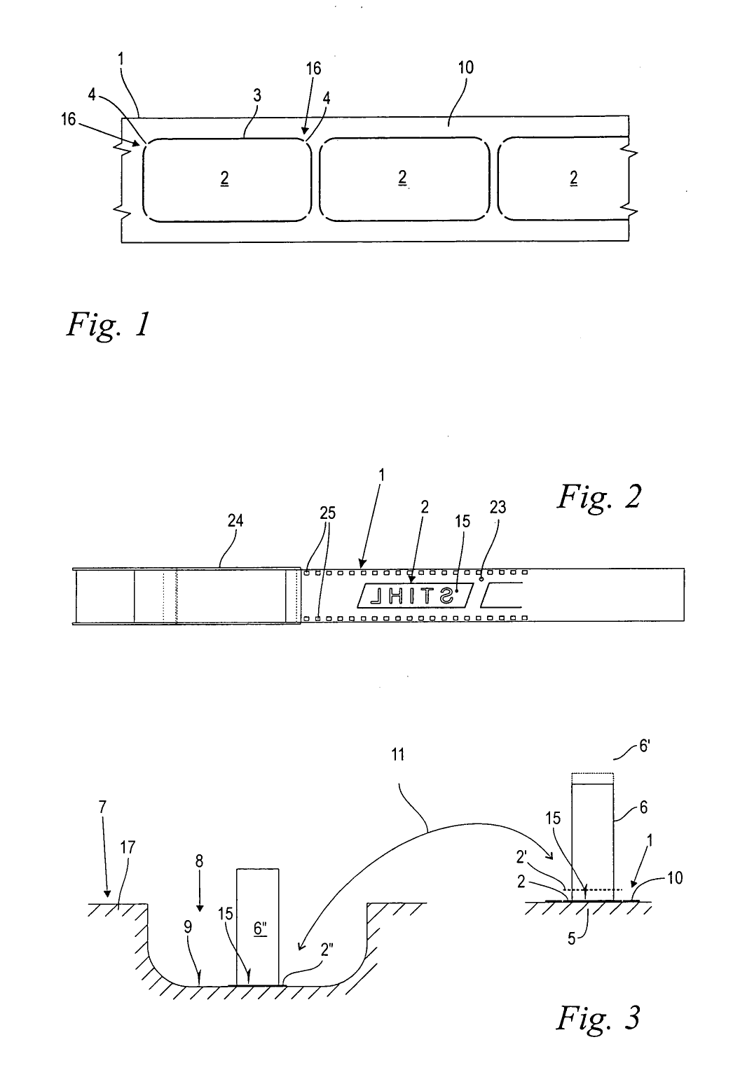

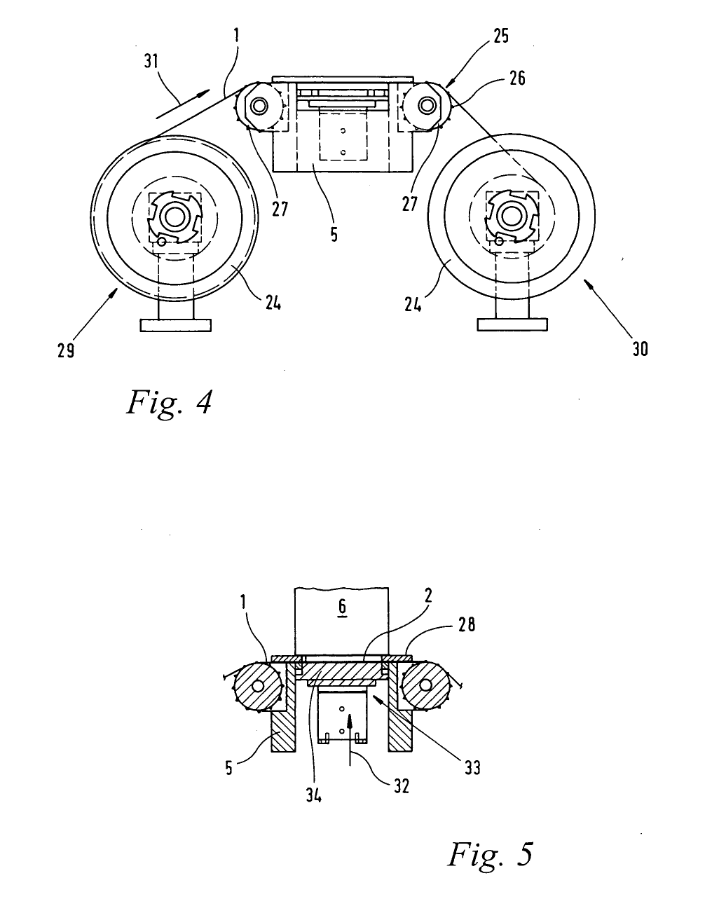

FIG. 1 shows a foil strip 1 in a schematic plan view with the foil strip being made of transparent, glass-clear polyamide (PA 6). The foil strip 1 is of long length and is wound on a spool shown in FIGS. 2 and 4. For the sake of clarity, only a short unwound section is shown. The foil strip 1 can include a carrier foil on which a plurality of foil parts 2 is held. In the embodiment shown, the foil parts 2 are almost completely punched out along a partition line 3 in such a manner that a carrier lattice 10 remains outside of the foil parts 2. The foil parts 2 and the carrier lattice 10 conjointly define the foil strip 1.

The foil parts 2 have here, by way of example, rectangular contours having rounded edges 16. Other forms of the foil parts 2 can be provided as desired such as shown in FIG. 2. The punching out of the foil parts 2 at the partition lines 3 is undertaken in such a manner that a thin connecting segment 4 remains at each of the four corners 16 of the foil parts 2. These connecting segments hold the foil parts 2 in the carrier lattice 10. A number of connecting segments 4, which depart from the above, can also be practical. The individual foil parts 2 are at a spacing to each other in the region of the mutually adjacent edges so that the carrier lattice 10 can extend through between the foil parts. It can also be practical that the foil parts 2 are contiguous to one another in the longitudinal direction of the foil strip 1. In this region, only a common partition line 3 is provided. In this case, the carrier lattice 10 comprises two lateral strip-like edge portions. It can be advantageous to provide connecting segments 4 between the individual foil parts 2.

An embodiment of the foil strip 1 of FIG. 1 is shown in FIG. 2. The foil strip 1 is rolled up to a roll on a spool 24. The foil strip 1 carries a plurality of foil parts 2 of which only one is shown here to provide a better overview. On the rear side 15 of the foil part 2, which faces toward the viewer in FIG. 2, a written term is imprinted in mirror writing. This written term is read not mirror reversed from the front side 20 as shown in detail in FIG. 7 after being injected into the plastic molded part 12.

The foil strip 1 is provided with respective perforated edges 25 on its two longitudinal edges. The perforated edges 25 are formed with a plurality of openings disposed at equal spacings one to the other in the manner of a movie film. By means of the perforated edges 25, the foil strip 1 is rolled off from the spool 24 as shown in FIG. 4 and is guided over a support 5 shown in FIGS. 3 to 5.

Each of the foil parts 2 is assigned a positioning mark 23 whose function will be described in greater detail in connection with FIG. 4. The positioning mark 23 is preferably an imprinted point or a punched hole.

FIG. 3 shows a schematic of the preparation of an injection mold 7 for an injection molding operation to be performed later. An open lower mold half 17 has a mold recess 8 and is part of the injection mold 7. In the work region of the injection mold 7, a support 5 is provided on which the foil strip 1 of FIG. 1 or FIG. 2 is placed. The work region shown here is the displacement path of a grabber 6. The grabber 6 is moveable back and forth along a double arrow 11 between the support 5 and the injection mold 7.

According to the method of the invention, the foil strip 1 of FIG. 1 or 2 is positioned on the support 5 in such a manner that the schematically indicated grabber can take up at least one of the foil parts which are provided in the foil strip 1. The grabber 6 includes a vacuum lift (not shown) with which it grabs the foil part 2 and lifts the same. The foil strip 1 lies with its imprinted rear side 15 directed upwardly, that is, the rear side 15 faces away from the support and faces toward the grabber 6.

In the embodiment shown, the grabber 6 is positioned above a foil part 2 and lowered. The grabber 6 draws the foil part 2 by suction and lifts it with a suitable lift movement from the support 5 into the position identified by reference character 2′. The carrier lattice 10 is held tightly against the support 5 so that the connecting segments 4 (FIG. 1) tear because of the lift movement of the grabber 6 together with the foil part 2. The foil part 2 is therefore only detached from the foil strip 1 by the lift movement of the grabber 6. Alternatively, a cutting out or punching out or a tearing out can take place during or in advance of the lifting of the foil part as shown, for example, in FIGS. 4 and 5.

Proceeding from the position identified by reference character 6′, the grabber 6 together with the foil part 2 moves into the mold recess 8 of the injection mold 7 until the positions identified by 2″ and 6″ are assumed. Here, the foil part 2 lies on an essentially smooth surface region 9 of the mold recess 8. The smooth surface region 9 is larger than the surface of the foil part 2 lying thereon. A region is identified as the essentially smooth surface region 9 which is free of sharp edges, steps or the like. The foil part 2 lies in a real contact on the smooth surface region 9 and is held in position, for example, electrostatically or in a suitable other manner. The rear side 15 of the foil part 2 lies facing upwardly as it does on the support 5, that is, in the direction toward the grabber 6 or opposite to the surface region 9.

FIG. 4 shows a side elevation view of the arrangement of FIG. 3 in the region of the support 5. The foil strip 1 is moved over the support 5 along its longitudinal direction in the direction of arrow 31. For this purpose, an unwind unit 29 and a wind-up unit 30 are provided which each include a spool 24. The new unused foil strip 1 is first rolled up on the spool 24 of the unwind unit 29 and is guided over the support 5 to the spool 24 of the wind-up unit 30.

Guide rollers 27 are provided on respective ends of the support 5. The guide rollers 27 each have a plurality of teeth 26 distributed on their respective edges. The teeth 26 engage in the holes (FIG. 2) of the respective perforated edges 25. At least one of the two guide rollers 27 is driven and ensures a transport of the foil strip 1 in the direction of arrow 31 via the teeth 26 and the perforated edges 25. The spool 24 of the unwind unit 29 is braked for this purpose whereas the spool 24 of the wind-up unit 30 is manually or motorically driven in the direction of arrow 31. It can also be practical to provide for the transport of the foil strip 1 in the direction of arrow 31 via the wind-up unit 30. The guide rollers 27 are then not driven. If required, the configuration of the teeth 26 and the perforated edges 25 can be omitted.

The transport of the foil strip 1 in the direction of arrow 31 takes place at first until the foil strip 2 lies in overlapment with a separating device 33 as shown in FIG. 5. There, the support 5 of the arrangement of FIG. 4 is shown in longitudinal section. Therefore, the separating device 33 is integrated into the support 5 and includes a swage 34 as well as a hold-down device 28. The hold-down device 28 acts from above on the support 5. The foil strip is passed between the hold-down device 28 and the support 5. The grabber 6 lies from above on the hold-down device 28.

The positioning of the foil part 2, which is held in the foil strip 1, relative to the separating device 33 takes place by means of the positioning mark 23 shown in FIG. 2. The relative position of the foil part 2 to the separating device 33 can be measured or checked based on the positioning mark 23. As soon as the foil part 2 lies in overlapment with the separating device 33, the transport of the foil strip 1 in the direction of arrow 31 shown in FIG. 4 is stopped. The foil part 2 can now be separated from the foil strip 1. The positioning mark 23 can be read out preferably automatically via optical or mechanical means. In lieu of a separate positioning mark 23 (FIG. 2), the perforated edges 25 (FIGS. 3 and 4) can be applied for positioning the foil part 2. A precise positioning can be provided, for example, in combination with a step motor which acts on the guide rollers 27 having the teeth 26 (FIG. 4). When driving the foil strip 1 via the spool 24 of the wind-up unit 30 (FIG. 4), the position of the foil part 2 can also be determined by a rotation-measuring sensor via the perforated edges 25 and a guide roller 27 driven thereby.

As indicated in FIG. 5, the swage 34 is raised from below upwardly in the direction of arrow 32 to separate out the foil part 2 from the foil strip 1. At the same time, the carrier lattice 10 (FIG. 1) is held by the hold-down device 28 on the support 5 and against a lift off. The hold-down device 28 is provided with an opening in the form of the outline of the foil part 2 and thereby forms a cutting edge for the swage 34. With the stroke movement of the swage 34 in the direction of arrow 32, the foil part 2, which lies on the swage 34, is likewise raised and pressed upwardly through the opening of the clipping edge (that is, the opening of the hold-down device 28) and is transferred to the grabber 6 lying thereupon. The connecting segments 4 (FIG. 1) are torn thereby.

Alternatively, it can also be practical to configure the swage 34 and the hold-down device 28 as a cutting device or punching device with which the foil part 2 is punched out of the foil strip 1 with the hold-down device 28 being configured as a cutting edge. Likewise, it can be practical to undertake the separation of the foil part 2 in the direction opposite to that indicated by arrow 32. Here, the grabber 6 can, for example, be part of the separating device 33 and thereby constitute the hold-down device 28 and/or the swage 34.

The separation of the connecting segments 4 shown in FIG. 1 can also be a complete punch out of the foil part 2 from the foil strip 1 in a manner described above.

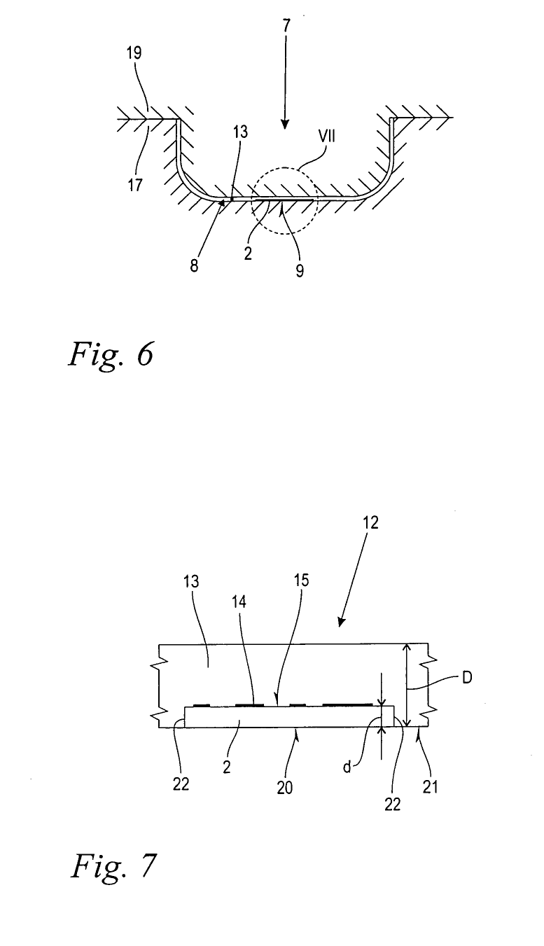

In FIG. 6, the injection mold 7 of FIG. 2 is shown in the closed condition. An upper mold half 19 is seated on the lower mold half 17 so that the mold recess 8 is closed off. The foil part 2 lies in surface contact on the planar surface region 9 and with the foil part 2 in this position, the mold recess 8 is injection filled with plastic 13. In this process, the foil part 2 receives the injected plastic 13 from behind (back injected). The plastic material of the back injected plastic 13 is the same as that of the foil part 2, namely, polyamide (here, PA 6). However, departing from the foil part 2, no clear plastic is injected; rather, a polyamide, which is dyed throughout, is injected. As may be required, also a filling with short fibers of glass or the like can be practical.

A detail of the plastic molded part 12 is identified by VII in FIG. 6 and is injected into the injection mold 7. This plastic molded part 12 is shown schematically in FIG. 7. The plastic molded part 12 is here shown, by way of example, as a housing component of a portable handheld work apparatus. The portable handheld work apparatus can be a chain saw, brushcutter, cutoff machine or the like. Accordingly, the foil part 2 has a front side 20 lying opposite its rear side 15 and this front side lies flush and without a gap on the planar surface region 9 in the injection mold 7 (FIG. 6). The rear side 15 of the foil part 2 is back injected with the plastic 13. The plastic 13 has flowed in about the lateral edges 22 of the foil part 2. A side 21 of the plastic 13 or of the plastic molded part 12 exposed to a person viewing the same therefore transitioning flush and step free into the front side 20 of the foil part 2.

The foil part 2 is partially imprinted on its rear side 15 with the print ink being indicated by reference numeral 14 in FIG. 7. In addition to its color-imparting characteristic, the print ink 14 also defines a bonding agent between the foil part 2 and the back injected plastic 13. It can also be practical to provide a separate bonding agent. This bonding agent can, as may be required, be introduced between the print ink 14 and the plastic 13 as well as between the non-imprinted sections of the rear side 15 and the plastic 13. In the embodiment shown, the non-imprinted sections of the rear side 15 are not provided with a separate bonding agent. The bonding between the foil part 2 and the plastic 13 results from the sameness of the two selected plastic materials.

The foil part 2 has a thickness (d) which is preferably in the range from 14 μm to 200 μm inclusive. In the embodiment shown, the thickness (d) is approximately 14 μm. The thickness (d) of the foil part 2 can also be greater. However, according to the invention, the ratio of the thickness (d) of the foil part 2 to the total thickness D of the plastic molded part 12 in the region of the back injected foil part 2 is less than 0.5.

The print ink 14 is preferably applied to the rear side 15 of the foil part 2 in a rolling silk screen process or tampon printing process. A good depth permeability for water vapor results in combination with the above-mentioned thickness ratios and the above-mentioned material selection. The formation of bubbles between the foil part 2 and the back injected plastic 13 is reliably avoided.

In the foil strip 1 shown in FIGS. 1 and 2, several like foil parts 2 are arranged in a row. It can be practical to arrange several foil strips one next to the other on the support 5 out of which different foil parts 2 can be taken by means of the shown grabber 6 and placed in the mold recess 8. If required, these foil strips can be different. Also, if required, a multi-grabber can be provided which simultaneously lifts several foil parts 2 and places the same. In a practical further embodiment, several foil parts 2 are arranged as a set in a single foil strip 1. These foil parts 2 can then be different if required.

It is understood that the foregoing description is that of the preferred embodiments of the invention and that various changes and modifications may be made thereto without departing from the spirit and scope of the invention as defined in the appended claims.

What is claimed is:

1. A method of making a plastic form part including a housing part of a portable handheld work apparatus, the method comprising the steps of:
providing a foil strip containing a plurality of foil parts;
positioning the foil strip in a work region of an injection mold;
taking a foil part from said foil strip and placing said foil part in said injection mold utilizing a grabber; and,
injecting plastic into said injection mold so as to cause said plastic to be applied to said foil part at the rear side thereof.

2. The method of claim 1, comprising the further steps of:
partially punching out at least one of said foil parts from said foil strip while retaining connecting segments which continue to hold the foil part in said foil strip and so cause the remaining regions of said foil strip to form a carrier lattice for said foil part; and,
cutting through said connecting segments directly in advance of taking said foil part from said foil strip.

3. The method of claim 2, wherein said connecting segments are severed utilizing said grabber.

4. The method of claim 1, wherein said injection mold is part of an injection mold assembly which includes said grabber, a support and a hold-down device; and, wherein said method comprises the further steps of:
holding said foil strip between said hold-down device and said support when taking said foil part from said foil strip; and,
separating said foil part from said foil strip.

5. The method of claim 4, wherein said foil part is separated from said foil strip by punching out or tearing out said foil part from said foil strip.

6. The method of claim 1, wherein said foil parts in said foil strip have positioning marks assigned thereto; and, wherein said method comprises the further step of positioning said foil strip utilizing said positioning marks for taking said foil part from said foil strip.

7. The method of claim 1, wherein said plastic is injected into said mold so as to be applied to said foil part on the rear side thereof with said foil part being made of the same plastic material as said plastic injected into said injection mold.

8. The method of claim 7, wherein said foil part and the injected plastic are polyamide.

9. The method of claim 1, wherein said foil part is made of clear plastic printed at least partially on the rear side thereof.

10. The method of claim 9, wherein said rear side of said foil part faces toward the plastic injected into said injection mold; and, wherein said method comprises the further step of applying a bonding agent to said rear side.

11. The method of claim 10, wherein said bonding agent is defined by an applied printing ink.

12. The method of claim 1, wherein said plastic is a plastic colored throughout.

13. The method of claim 12, wherein said plastic is a filled plastic.

14. The method of claim 1, wherein said foil part has a thickness (d) in the range of 14 μm to 200 μm inclusive.

15. The method of claim 14, wherein said thickness (d) is approximately 14 μm.

16. The method of claim 1, wherein said housing part is a plastic molded part and formed by injecting plastic into said injection mold including onto the rear side of said foil part thereby causing said foil part to become part of said plastic molded part; and, the ratio of the thickness (d) of said foil part to the overall thickness (D) of said plastic molded part in the region of the foil part is less than 0.5.

17. The method of claim 1, wherein said injection mold has an essentially smooth surface region and said foil part is placed on said surface region.
